(19) United States
(12) Patent Application Publication
(10) Pub. No.: US 2009/0211535 A1
(43) Pub. Date: Aug. 27, 2009

(54) PET CAGE SANITARY DEVICE

(76) Inventor: Richard A. Santana, Simi Valley, CA (US)

Correspondence Address: CHANCELLOR IP, 3463 RED BLUFF CT., SEMI VALLEY, CA, 93063, US

(21) Appl. No.: 12/388,413

(22) Filed: Feb. 18, 2009

Related U.S. Application Data
(60) Provisional application No. 61/031,678, filed on Feb. 26, 2008.

(51) Int. Cl. A01K 31/00; A01K 29/00; A01K 31/06; A01K 31/04

(52) U.S. Cl. 119/459; 119/161

(57) ABSTRACT

A pet cage sanitary device utilizes a tacky surface for collecting migrant materials within the cage.

### PRIORITY CLAIM

This patent application claims the benefit of U.S. Provisional Patent Application No. 61/031,678 for PET CAGE SANITARY DEVICE filed Feb. 26, 2008.

### BACKGROUND OF THE INVENTION

### Field of the Invention

The present invention relates to a device utilizing an adhesive for collecting and aiding in the removal of materials from a pet environment such as a bird cage.

### SUMMARY OF THE INVENTION

A pet cage sanitary device comprises a substrate and an adhesive coating applied to at least a portion of the substrate. In an embodiment, the adhesive coating is located within a pet cage and positioned to be contacted by migrant pet cage materials such that the adhesive coating is operable to immobilize at least a portion of the migrant pet cage materials.

In an embodiment, a first color is characteristic of at least some of the pet cage materials and a second color contrasts with the first color. A surface bears the second color and this colored surface is at least partially obscured from view when pet cage materials of the first color are immobilized on the adhesive coating. The contrasting first and second colors visible on the adhesive coating provide an indication of the consumption of the lifetime of the pet cage sanitary device.

In an embodiment, the pet cage sanitary device further comprises a barrier tending to prevent contact between a pet and the adhesive coating. The barrier is formed by a plurality of substrate projections and the adhesive coating is applied between adjacent projections to form tacky pockets. The shape, size and spacing of the projections are selectable to accommodate different pets.

A pet cage comprises first and second spaces and the first space is separated from the second space by a pervious barrier. A pet is located in the first space and a pet cage sanitary device is located in the second space. The pet cage sanitary device has a tacky surface for collecting materials passing from the first space to the second space. The barrier prevents the pet in the first space from coming into contact with the tacky surface of the pet cage sanitary device.

In an embodiment, a first color is characteristic of at least some of the pet cage materials and a second color contrasts with the first color. The second color is at least partially obscured from view by pet cage materials immobilized on the tacky surface. The contrasting first and second colors visible on the tacky surface provide an indication of the consumption of the lifetime of the pet cage sanitary device.

In an embodiment, a flexible substrate bears the tacky surface and the tacky surface is covered by a flexible protective layer. The substrate and protective layer are spooled onto a supply roll. A first take-up roll is operative to spool the substrate and a second take-up roll is operative to spool the protective layer. Coordinated operation of the supply and take-up rolls renews the tacky surface between the supply roll and the first take-up roll.

### BRIEF DESCRIPTION OF THE DRAWINGS

The present invention is described with reference to the accompanying figures. These figures, incorporated herein and forming part of the specification, illustrate embodiments of the present invention and, together with the description provide examples enabling a person skilled in the relevant art to make and use the invention.

FIG. 1 is a schematic side view of a pet cage such as a bird cage incorporating the pet cage sanitary device of the present invention.

FIG. 2 is a cross-sectional view of a portion of an embodiment of the pet cage sanitary device of FIG. 1.

FIG. 3 is a perspective view of a pet cage sanitary device of FIG. 1.

FIG. 4 is a cross-sectional view of a portion of another embodiment of the pet cage sanitary device of FIG. 1.

FIG. 5 is a cross-sectional view of a portion of yet another embodiment of the pet cage sanitary device of FIG. 1.

FIG. 6 is a schematic side view of rolls for use with the pet cage sanitary device of FIG. 1.

### DETAILED DESCRIPTION OF THE PREFERRED EMBODIMENTS

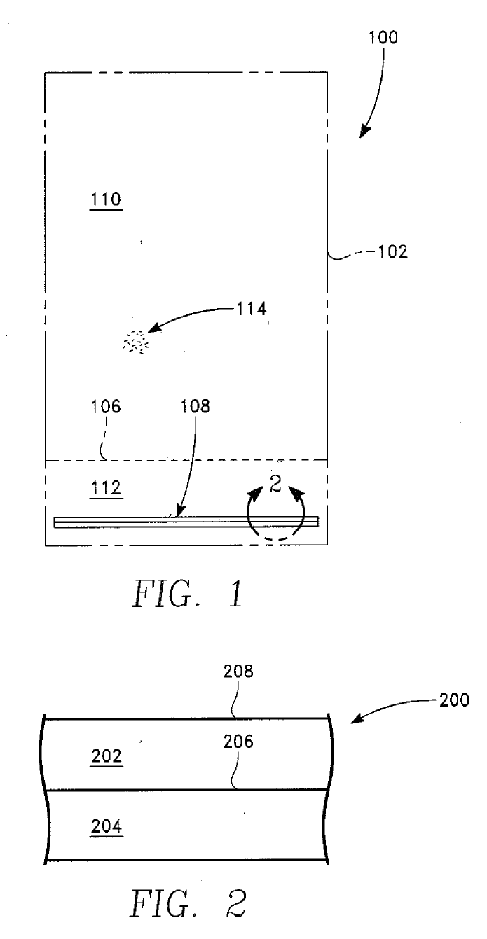

FIG. 1 shows a schematic cross-sectional view 100 of a pet cage, such as a bird cage. The cage includes an outer barrier such as a wire screen or grid 102 suitable for containing a pet. In various embodiments, structural elements supporting the outer barrier include one or more of upright, circumferential and transverse members. For clarity, these members are not shown in this figure. A second barrier 106 separates a first space 110 for enclosing a pet from a second space 112 for enclosing a pet cage sanitary device 108. The second barrier is pervious, allowing materials such as hair, dander, allergens, fur, feathers, pet food and other materials 114 found in similar pet cages to pass from the first space to the second space. In an embodiment, the second barrier 106 is constructed in a fashion similar to the outer barrier. In some embodiments, the second barrier is constructed of another suitable material such as a moldable material having penetrations created during the molding process.

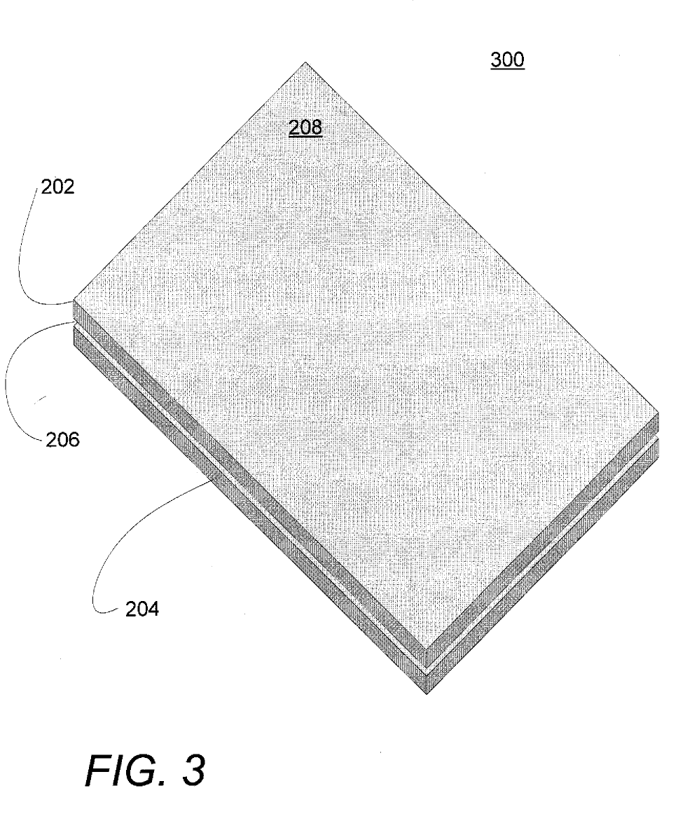

FIG. 2 shows a cross-sectional view 200 of a portion of an embodiment of the pet cage sanitary device of FIG. 1. FIG. 3 shows a perspective view 300 of a pet cage sanitary device of FIG. 1. The pet cage sanitary device 108 includes a substrate layer 204 and an adhesive layer 202. In an embodiment, the pet cage sanitary device includes a single substrate layer and an adhesive layer, the adhesive layer covering a surface 206 of the substrate layer.

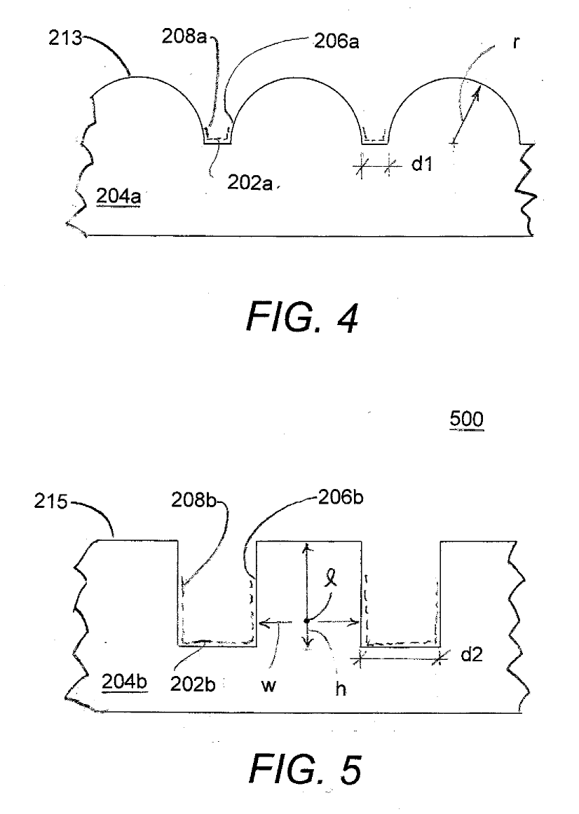

FIG. 4 shows a cross-sectional view 400 of a portion of another embodiment of the pet cage sanitary device of FIG. 1. Unlike the relatively smooth substrate surface 206 of the device of FIG. 2, this embodiment has a substrate 204a with an irregular exposed surface 206a characterized by rounded projections 213. And, unlike the extensive adhesive exposed surface 208 of the device of FIG. 2, this embodiment includes an adhesive layer 202a applied between adjacent projections to form tacky first pockets 208a. By choosing suitable projection radii “r” and a suitable distance “d1” between projections, the adhesive pockets immobilize pet cage materials 114 while providing a barrier against accidental adhesive/pet attachment.

FIG. 5 shows a cross-sectional view 500 of a portion of yet another embodiment of the pet cage sanitary device of FIG. 1. Unlike the relatively smooth substrate surface 206 of the device of FIG. 2, this embodiment has a substrate 204b with an irregular exposed surface 206b characterized by cubic projections 215. And, unlike the extensive adhesive exposed surface 208 of the device of FIG. 2, this embodiment includes adhesive layer 202b applied between adjacent projections to form tacky second pockets 208b. By choosing suitable cubic length “l,” height “h,” and width “w,” and a suitable distance(s) between projections “d2,” the adhesive pockets immobilize cage materials 114 while providing a barrier against accidental adhesive/pet attachment.

As will be clear to persons of ordinary skill in the art, other suitable geometries are available for forming adhesive pockets that include a barrier against accidental adhesive/pet attachment.

Suitable adhesive layers 202 are made from materials that present a tacky exposed surface 208 for collecting materials 114 passing from the first space to the second space. In some embodiments, the adhesive is selected for its ability to adhere to some, but not all of the materials which pass from the first space to the second space.

In some embodiments, colored adhesive materials are used to provide a tell-tale for replacement of the pet cage sanitary device. For example, white danders collected by the pet cage sanitary device contrast with colors such as black, red and others. Therefore, use of such a contrasting color provides the mentioned tell-tale indicating the need for renewal of the pet cage sanitary device when the color is somewhat obscured by the material being collected.

Materials from which suitable adhesive layers 202 may be formed are generally non-toxic materials. In an embodiment, the adhesive exhibits the desired tacky quality within normal room temperature ranges. In some embodiments, the desired tackiness is maintained in a first temperature range of between about 60 and 80 degrees Fahrenheit. In another embodiment, the desired tackiness is maintained in a second temperature range between 55 and 85 degrees Fahrenheit.

Products meeting these requirements include polymers and mixtures of polymers, natural glues and adhesives, rubber products and other adhesives known to persons of ordinary skill in the adhesive arts. For example, non-toxic polymeric glues and adhesives for catching pests may be used to form the adhesive layer. One such product is Atlantic Paste & Glue's Catchmaster™ glue, a product commonly used in insect traps.

Suitable substrate layers 204 are made from one or more materials capable of being fabricated to present an exposed surface to which an adhesive layer 202 will attach. Such materials include polymeric and other suitable synthetic substrates, sheets and films, papers, including card stock, craft paper, cardboard, paste board, and other suitable papers and paper fabrications including specialty papers and paper fabrications. In some embodiments, polymeric materials such as polymeric foams are used to form the irregular substrates of FIGS. 4 and 5.

In an embodiment, the substrate is chosen for ease of trimming and cutting portions of pet cage sanitary devices 108 such as for enabling the use of household scissors to trim a pet cage sanitary device to fit a particular space within a particular cage. And, in an embodiment, the substrate is perforated in various patterns matching selected dimensions of common pet cages. Here, tearing, cutting or otherwise separating along perforations matching selected cage dimensions provides a custom fitted pet cage sanitary device.

In an embodiment, the substrate is chosen to allow the substrate 204 coated with an adhesive 202 to be rolled in a compact form. In some embodiments, the adhesive's exposed surface 208 is covered with or enveloped by a protective paper or film such as waxed paper; here, the protective film is removed as needed prior to placing the exposed portions of adhesive surface into service collecting pet cage materials 114.

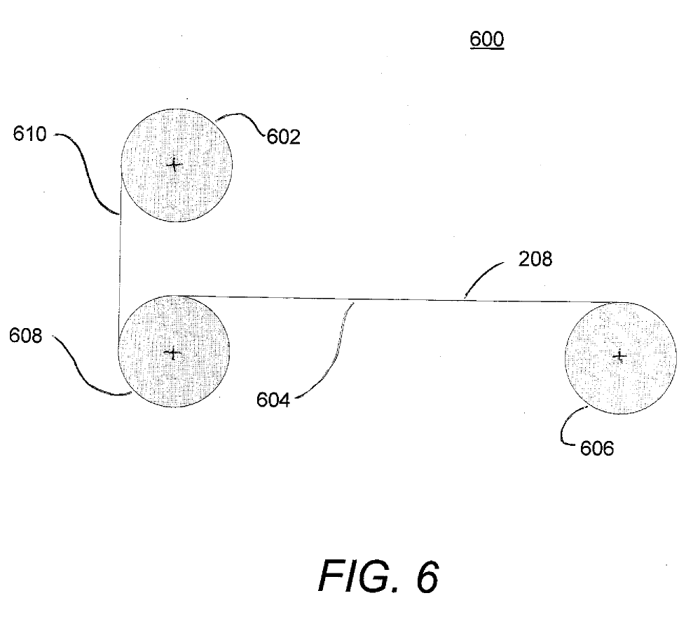

FIG. 6 shows an automated embodiment utilizing rolls 600. A supply roll 608 and a take-up roll(s) 606, 602 provide automatic renewal of the adhesive surface. Here, a flexible adhesive coated substrate 604 is spooled onto the supply roll. In the case that a flexible protective layer 610 is needed to protect the adhesive surface, an additional take-up roll 602 is used to spool the protective layer (as shown). During use, an operation including supply roll de-spooling and take-up roll spooling enables automated renewal of the adhesive layer and “packaging” of the waste materials within the layers on the take-up roll. In some embodiments, a first take-up roll 602 is used to take-up the protective layer and a second take-up roll 606 is used to take-up the adhesive coated substrate. As persons of ordinary skill in the art will understand, motive forces such as hand cranks or one or more electric motors will be needed to operate the roll(s).

Typical of the operation of the pet cage sanitary device 108 is its use in a bird cage. Here, an upper cage space 110 housing one or more birds is separated from a lower cage space 112 by a wire grid floor 106 that allows materials from the upper space 114 to pass to the lower space while preventing the birds from entering the lower space. A pet cage sanitary device located in the lower cage space with its tacky exposed side 208 facing up becomes a collector for materials passing from the upper cage space to the lower cage space. The pet cage sanitary device adhesively attaches to materials it comes into contact with. In particular, the pet cage sanitary device immobilizes, inter alia, small particulates which would otherwise be dispersed by forces tending to accelerate them such as air currents and motions.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A pet cage sanitary device comprising:
a substrate;
an adhesive coating applied to at least a portion of the substrate;
the adhesive coating located within a pet cage;
the adhesive coating positioned to be contacted by migrant pet cage materials; and,
the adhesive coating operable to immobilize at least a portion of the migrant pet cage materials.

2. The pet cage sanitary device of claim 1 further comprising:
a first color, said color being characteristic of at least some of the pet cage materials;
a second color contrasting with the first color;
a surface bearing the second color;
the colored surface being at least partially obscured from view by pet cage materials of the first color immobilized on the adhesive coating; and,
the contrasting first and second colors visible on the adhesive coating providing an indication of the consumption of the lifetime of the pet cage sanitary device.

3. The pet cage sanitary device of claim 1 further comprising:
a barrier tending to prevent contact between a pet and the adhesive coating;
the barrier formed by a plurality of substrate projections;
the adhesive coating applied between adjacent projections to form tacky pockets; and,
the shape, size and spacing of the projections being selected to accommodate different pets.

4. A pet cage comprising:
first and second spaces, the first space separated from the second space by a pervious barrier;
a pet located in the first space and a pet cage sanitary device located in the second space;
the pet cage sanitary device having a tacky surface for collecting materials passing from the first space to the second space; and,
the pervious barrier tending to prevent the pet in the first space from coming into contact with the tacky surface of the pet cage sanitary device.

5. The pet cage of claim 4 further comprising:
a first color, said color being characteristic of at least some of the pet cage materials;
a second color contrasting with the first color;
the second color being at least partially obscured from view by pet cage materials immobilized on the tacky surface; and,
the contrasting first and second colors visible on the tacky surface providing an indication of the consumption of the lifetime of the pet cage sanitary device.

6. The pet cage of claim 4 further comprising:
a flexible substrate bearing the tacky surface;
the substrate wrapped around a supply roll;
a take-up roll operative to spool the substrate; and,
coordinated operation of the supply and take-up rolls operative to renew the tacky surface between the supply roll and the take-up roll.
